(19) United States
(12) Patent Application Publication
(10) Pub. No.: US 2024/0412170 A1
(43) Pub. Date: Dec. 12, 2024

(54) SYSTEM AND METHOD FOR HIRING PERSONS TO PERFORM SERVICES ON A TEMPORARY BASIS

(71) Applicant: Mark Lamoncha, Columbiana, OH (US)

(72) Inventor: Mark Lamoncha, Columbiana, OH (US)

(21) Appl. No.: 18/440,081

(22) Filed: Feb. 13, 2024

Related U.S. Application Data
(63) Continuation-in-part of application No. 18/342,147, filed on Jun. 27, 2023.
Application No. 18/342,147 is a continuation-in-part of application No. 17/388,147, filed on Jul. 29, 2021.
Application No. 17/388,147 is a continuation-in-part of application No. 16/286,142, filed on Feb. 26, 2019, now Pat. No. 11,797,937.
(63) Continuation-in-part of application No. 16/286,142, filed on Feb. 26, 2019, now Pat. No. 11,797,937.
(60) Provisional application No. 62/635,062, filed on Feb. 26, 2018.

(51) Int. Cl. G06Q 10/1053; G06Q 50/10; G06T 19/00

(52) U.S. Cl. CPC G06Q 10/1053; G06Q 50/10; G06T 19/006

(57) ABSTRACT

A server hosts an application for hiring persons to perform services on a temporary basis. At least one hiring user electronic device and at least one worker user electronic device are placed in communication with the server. Following indication of agreement between a respective worker users and hiring users, information related to a task for which the worker is hired is displayed at an augmented reality devices associated with the respective worker user, such as to provide instructions for the task.

### CROSS-REFERENCE TO RELATED APPLICATION

This application is a continuation in part of U.S. application Ser. No. 18/342,147 filed Jun. 27, 2023, which is a continuation in part of U.S. application Ser. No. 17/388,147 filed Jul. 29, 2021, which is a continuation in part of U.S. application Ser. No. 16/286,142 filed Feb. 26, 2019, which claims the benefit of U.S. Provisional Application Ser. No. 62/635,062 filed Feb. 26, 2018; this application is also a continuation in part of U.S. application Ser. No. 16/286,142 filed Feb. 26, 2019; the disclosures of each of the foregoing are hereby incorporated by reference as if fully restated herein.

### TECHNICAL FIELD

Exemplary embodiments of the present invention relate generally to a system and method for hiring individuals to perform services on a temporary basis.

### BACKGROUND AND SUMMARY OF THE INVENTION

Companies sometimes require assistance above and beyond the capacity of their current workforce. Individuals sometimes require assistance for tasks they do not have the resources, skills, or desire to complete. Companies and individuals may either require additional laborers or they may require a person having specialized knowledge or tools that are not available among those in their current workforce or resources. The assistance needed may involve manual or skilled labor. Often times, the company or individual looking to hire services needs a person or persons who can help for a period of time (e.g., a number of hours) or for a particular project (e.g., a number of widgets made), but does not necessarily have the need or desire to bring on said person or persons on a permanent, semi-permanent, and/or full-time basis.

Similarly, individuals or companies looking to be hired often face the problem of having additional time or interest in further work that they are not currently employed for, or that is not fulfilled by their current employment. Such people may have un- or under-utilized time, skills, tools, or other resources that could otherwise be translated into dollars as well as additional training and experience. However, such individuals often do not have the time or interest in working a first, second, third, etc. such job on a permanent, semi-permanent, and/or full-time basis. Instead, such persons are generally available to help for a period of time (e.g., a number of hours, a number of days, etc.) or for a particular project (e.g., fixing something, making a number of widgets, etc.).

Additionally, the process of seeking and becoming employed as temporary labor is burdensome. Often times, this process is so burdensome that it renders the individuals or companies looking to hire and looking to be hired unwilling to do so, despite having a need for it—this is especially true of particularly small projects like unclogging a sink, raking leaves, or re-wiring a lamp, for example without limitation. The traditional route of applying to a temporary placement agency, matching candidates to positions, performing the hiring, and onboarding such person or persons is particularly time consuming and costly—both for the company or individual doing the hiring and for the person or persons being hired. Furthermore, there are significant delays in this process, when individuals or companies often times need the additional help immediately.

Therefore, what is needed is a system and method that facilitates the hiring of persons to perform services on a temporary basis. These disclosures provide a system and method that facilitates the hiring of persons to perform services on a temporary basis.

In exemplary embodiments, a software application (“app”) may be installed and executed on a personal electronic device, where the app facilitates such hiring. The app may be utilized by worker users who create profiles that provide information about themselves or their company which are available for hiring. Such information may include the type of work they are interested in, photos, resume information, payment information, skills, tools, and the like. Hiring users may also create profiles with information about themselves or their company as well as payment information. Hiring user may create job entries which include the services needed and geographic information.

The app may be configured to present the hiring user with a list of possible matching worker users. The worker users available for immediate hire may be indicated on a list and/or on a map of the area with a symbol. In other exemplary embodiments, the app may instead be configured to present the worker user with a list of possible matching jobs. The jobs available for immediate hire may be indicated on a list and/or on a map of the area with a symbol. The app may facilitate further negotiations between worker users and the hiring user, if desired.

Once an agreement is reached, the worker user shows up to work. In exemplary embodiments, the worker user may present a validation device to the hiring user to verify who the worker user is. Such validation may be performed at the app. The validation device may be provided to the worker user upon registration of the worker user at the app. After completing the work and confirming that the same has been done, the worker compensation is calculated and disbursed by way of the app. The app may permit the worker user to provide feedback regarding the hiring user. Similarly, the app may permit the hiring user to provide feedback regarding the worker user. The app may further track and provide periodic (e.g., monthly, quarterly, end of year, etc.) summary information to the worker user as well as the hiring user for business record keeping as well as tax purposes. In exemplary embodiment, the validation device, along with any certification and training credentials, may be stored on an electronic fob and/or peripheral device that attaches to the worker user's device. Attachment of the fob and/or peripheral device may activate the worker user's availability status.

Certain regulations, rules, laws, or the like may not be applicable to owners of a legal entity such as a company. Examples may include certain workplace safety regulations, rules, laws, or the like. Thus, it may be desirable in some circumstances to make hired individuals or entities at least part owners of the hiring entity to potentially avoid such regulations, rules, laws, or the like. Systems and methods are provided which render hired individuals or entities temporary part owners of the hiring entity in an automated fashion.

The system may be configured to electronically transfer a partial ownership interest in an entity using the system for hiring individuals or entities on a temporary basis to a holding company. Such electronic transfer may be provided, at least in part, by way of one or more automatically and electronically produced form documents which are automatically generated and at least partially filled in by the system, and may be electronically signed by, or on behalf of, the hiring entity. The system may be configured to electronically transfer such partial ownership interests to a temporarily hired individual or entity. Such electronic transfer may be provided by the same or different form documents. In exemplary embodiments, such electronic execution, generation, fill, storage, and/or transfer of the form documents may be made by way of the electronic peripheral devices. In exemplary embodiments, without limitation, the system may be configured to only initiate electronic transfer upon connection of one or more of the electronic peripheral devices, and may be configured to automatically revert the transfer upon disconnection of one or more of the electronic peripheral devices. The system may be configured to automatically disburse payment to the temporarily hired individual or entity upon reversion of the partial ownership interest. Such disbursement may be in the form of one or more cryptocurrencies, electronic transfer, electronic check, combinations thereof, or the like.

Certain information may be communicated to temporarily hired persons after hiring. The communicated information may be specific to the job or task (may be referred to herein generally as either job or task) for which the person was hired. Such information may include, for example, instructions on how to perform the task. Preferably, such information is presented as a movie or images. In exemplary embodiments, without limitation, the information may be presented by way of one or more augmented reality devices, such as but not limited to the HOLOLENS available from Microsoft (https://www.microsoft.com/en-us/hololens) the VISION PRO device available from Apple (https://www.apple.com/apple-vision-pro/), and/or other smart glasses or lens type devices. Such instructions may be presented to guide the hired person in performing their task.

Alternatively, or additionally, tracking devices may be provided. The tracking devices may be integrated with the augmented reality devices and/or be provided separate therefrom (e.g., as independent devices). These devices may track and/or derive at least certain locations, orientation in space, movements, activities, and/or other actions undertaken by the worker user or affiliated hired person (may be referred to more generally herein as worker user). In this way, the hiring users may be able to confirm, or at least have a reasonable level of confidence, that the worker user is performing the job in question and/or performing in the manner desired (e.g., in line with instructions, in an efficient manner, etc.). Alternatively, or additionally, such monitoring may be used to track if/when a job is completed, such as for dispensing payment or taking other action.

Further features and advantages of the systems and methods disclosed herein, as well as the structure and operation of various aspects of the present disclosure, are described in detail below with reference to the accompanying figures.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1 is a plan view of an exemplary system in accordance with the present disclosures;

FIG. 1B is a plan view of an exemplary embodiment of the system of FIG. 1;

FIG. 2 is a flow chart of exemplary logic for registering a new hiring user and creating a new job;

FIG. 3 is an exemplary user interface for a new job entry;

FIG. 4 is another exemplary user interface for the new job entry;

FIG. 5 is another exemplary user interface for the new job entry;

FIG. 6 is another exemplary user interface for the new job entry;

FIG. 7 is another exemplary user interface for the new job entry;

FIG. 8 is a flow chart of exemplary logic for registering a new worker user;

FIG. 9A is an exemplary results list of worker users;

FIG. 9B is an exemplary results list of job entries;

FIG. 10 is an exemplary map of returned matches;

FIG. 11 is a flow chart of exemplary logic for hiring a worker user;

FIG. 12 is a flow chart of exemplary logic for selecting a job;

FIG. 13 is a flow chart of exemplary logic for worker verification;

FIG. 14 is an exemplary verification system;

FIG. 15 is a plan view of an exemplary payment and pricing system;

FIG. 16 is a flow chart of exemplary logic for the payment system of FIG. 15;

FIG. 17 is a plan view of another exemplary system in accordance with the present disclosures;

FIG. 18A is a flow chart with exemplary logic for use with the system of FIG. 17;

FIG. 18B is a flow chart with other exemplary logic for use with the system of FIG. 17;

FIG. 19 is an exemplary blockchain for use with the system of FIG. 17 and method of FIGS. 18A-18B;

FIG. 20 is a plan view of another exemplary embodiment of the system in accordance with the present disclosures; and

FIG. 21 is a flow chat with exemplary logic for using the system of FIG. 20.

### DETAILED DESCRIPTION OF EXEMPLARY EMBODIMENT(S)

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

Embodiments of the invention are described herein with reference to illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

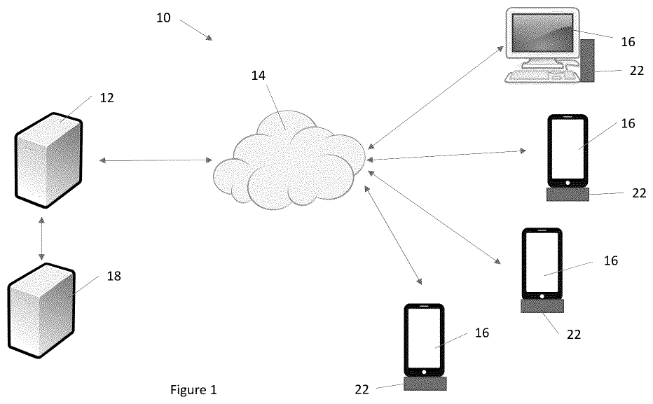

FIG. 1 is a plan view of an exemplary system 10. The system 10 may comprise a server 12 in communication with one or more user devices 16. The server 12 may be in communication with the user devices 16 by way of a network 14. The server 12 may comprise one or more electronic storage devices, processors, network connectivity devices, and the like. In exemplary embodiments, the network 14 may be the world wide web. However, it is contemplated that the network 14 may be any internet, intranet, cellular network, some combination thereof, or the like. One or more user devices 16 may be in communication with the server 12 by way of the network 14. The user devices 16 may be, without limitation, personal computers, desktop computers, laptops, tablets, smartphone, smart watches, cellular telephones, PDAs, or the like. The user devices 16 may comprise one or more electronic storage devices, processors, network connectivity devices, and the like.

A first subset of the user devices 16 may be operated by, or otherwise associated with, individuals or entities seeking to be hired (hereinafter also “worker users”). A second subset of the user devices 16 may be operated by, or otherwise associated with, entities or individuals seeking to hire others (hereinafter also “hiring users”). The communications described herein may be accomplished by a wired or wireless connection, some combination thereof, or the like. Executable software instructions may be provided, which may be stored on one or more of the electronic storage devices and may be executed by one or more of the processors. Such executable software instructions, when executed, may configure the one or more processors to provide the features and/or perform the operations described herein.

In exemplary embodiments, the server 12 may be configured to host an app that facilitates the hiring of persons or entities. Alternatively, or in addition, the server 12 may be configured to provide access to the app or information utilized when running the app. The user devices 16 may each comprise corresponding apps which may be accessed or installed thereon. In exemplary embodiments, input received on one or more of the user devices 16 may be translated and communicated to the server 12 and stored thereon. The data stored on the server 12 may then be accessible by the other user devices 16 by way of the app. In other exemplary embodiments, it is contemplated that the server 12 may alternatively, or additionally, host a website or the like to facilitate such data storage and communication. In such embodiments, the user devices 16 may each similarly access the data stored on the server 12 by way of an internet browser, network connectivity device, or the like. In still other exemplary embodiments, the app and corresponding information may be stored on the various user devices 16 and sent to the other user devices 16 as required. It is contemplated that some combination of the above may be utilized.

The server 12 may be in electronic communication with a payment processing module 18. The payment processing module 18 may be a credit or debit card processing module, a bank transfer module, or the like. The payment processing module 18 may be configured to facilitate credit or debit transitions, bank account transfers, direct deposits, and the like.

In exemplary embodiments, the system 10 may further comprise electronic peripheral devices 22. Each of the electronic peripheral devices 22 may be configured for connection to one of the user devices 16. Each of the electronic peripheral devices 22 may comprise a fob, or other device selectively connectable to an associated one of the user devices 16 by way of physical (e.g., USB, lighting port, etc.) and/or wireless (e.g., wi-fi, near field communication, etc.) electronic connection. Each of the electronic peripheral devices 22 may comprise one or more computing components such as, but not limited to, processors, electronic storage devices, computers, network communication equipment, combinations thereof, or the like. The electronic peripheral devices 22 may be configured to store electronic information regarding the user associated with the given user device 16. Such electronic information may include, for example without limitation, training, experience, certifications, payment information, verification information, other information used by the app, and the like. Connection of the peripheral device 22 to the user device 16 may cause the associated worker user to be indicated as available for hiring on the app. The user of a peripheral device 22 is not required. In other exemplary embodiments, such information may be stored at the user device 16, the server 12, some combination thereof, or the like.

As illustrated with particular regard to FIG. 1B, the system 10, and/or various components thereof, may be positioned in one or more orbital systems 11. The orbital systems 11 may comprise, for example without limitation, satellites, space stations, ships, orbiting platforms, high altitude balloons, dirigibles, combinations thereof, or the like. The orbital systems 11 may be configured for single or regular travel at or above the Kármán line by way of non-limiting example. Alternatively, or additionally, the system 10, and/or various components thereof, may be positioned in one or more offshore locations 13. The offshore locations 13 may comprise, for example without limitation, ships or other oceangoing vessels, offshore platforms, submersibles oil rigs, combinations thereof, or the like. The offshore locations 13 may be configured for single or regular travel in international waters. In exemplary embodiments, without limitation, the server 12 and/or payment modules 18, and/or related components may be placed in the orbital systems 11 and/or offshore locations 13. In this fashion, the system 10, and/or various components thereof, may be maintained in international jurisdictions (e.g., international waters). This may also, or alternatively, permit decentralization, increased reliability (e.g., from climate change, natural disaster, catastrophe backup, geographic accessibility, etc.) and/or global access. User addresses (e.g., IP addresses, physical addresses) may be recorded, such as at the server 12, at one or more of the orbital systems 11 and/or offshore locations 13 in exemplary embodiments, without limitation. Users may be provided a fractional ownership share of such orbital systems 11 and/or offshore locations 13 in exemplary embodiments, without limitation.

Portions of the server 12 may be geographically disbursed. For example, without limitation, some of the server 12, or components thereof, may be placed in orbital systems 11 and/or offshore locations 13 while others are provided at one or more land-based geographic locations.

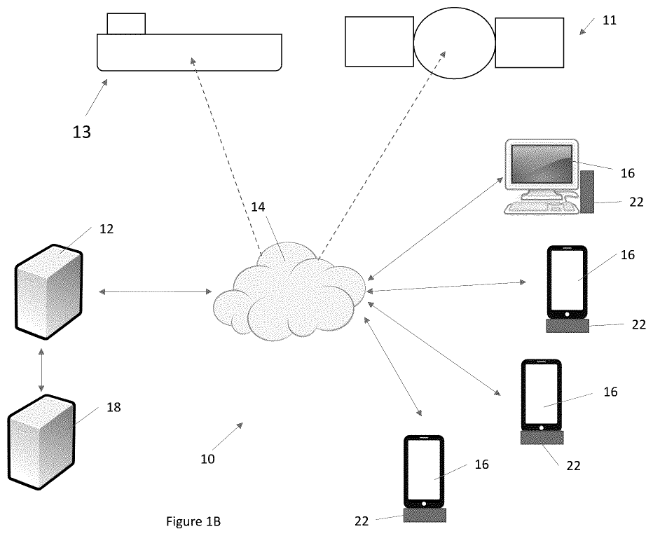

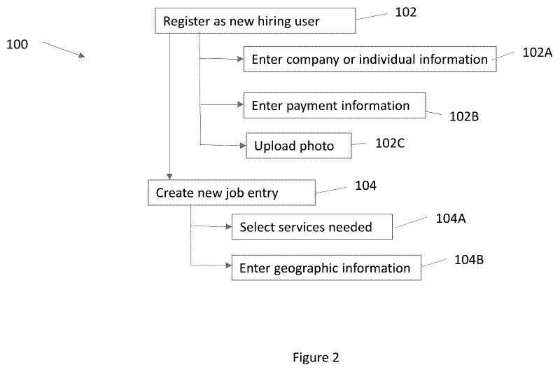

FIG. 2 is a flow chart of exemplary hiring user side logic 100 for the app. In exemplary embodiments, the hiring side logic 100 may be utilized with the system illustrated and described with respect to FIG. 1. More specifically, in exemplary embodiments, the hiring side logic 100 may represent steps, prompts, pages, interactions, or the like that are taken in conjunction with the operation of the app or website as utilized by an entity(s) or person(s) seeking to hire individuals. It is notable that the order of the steps provided herein is merely exemplary, any order of steps, including the repetition of one or more steps, is contemplated unless specifically stated otherwise.

In step 102, a new hiring user may register with the app or website. The registration process may prompt the user to input the following information, without limitation, hiring company or individual information (step 102A), payment information (step 102B), and a photo(s) (step 102C). The payment information, step 102B, may include the bank account information, credit card information, debit card information, or the like from which payment funds should be withdrawn, debited, credited, or the like. Such payment information processing may be performed at the payment processing module 18.

In exemplary embodiments, the hiring user may choose to import some or all of the hiring company or individual information at step 102A from another source such as, but not limited to, Facebook®, LinkedIn®, or the like. The categories of information listed with respect to steps 102A and 102B are merely exemplary, any number or types of categories of information requested is contemplated. Additionally, payment information 102B may be imported from a photo of a check, credit card, debit card, or the like. Furthermore, such payment information 102B may be imported from the hiring user's online banking portal.

If the hiring user is already registered, the user may instead log-in to their existing profile. The user may be presented with an option to update their profile as desired.

At step 104, the user may create one or more new job entries. The new job entry 104 may include, but is not limited to, the services needed (step 104A) and the geographic location the services are needed at (step 104B).

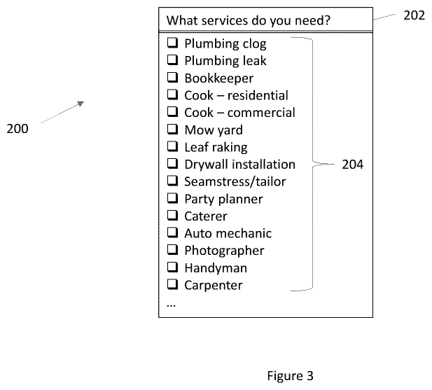

FIG. 3 is an exemplary user interface for a new job entry which may be encountered by a hiring user on their device 16 at step 104A of FIG. 2, though such is not required. The user interface may request service desired information 200. The hiring user may first encounter a prompt 202 asking the hiring user what services they are in need of. Any number of predefined service tasks 204 may be presented in a list with the ability to select one or more such services. Such selection may be made by touching, swiping, tapping, clicking, radio button, check box, or the like. In other exemplary embodiments, the user may be permitted to begin typing a description of the service required and a form may be prepopulated with suggestions of the predefined service tasks 204 for the hiring user to select. The predefined service tasks 204 shown in FIG. 3 are merely exemplary and are not intended to be limiting.

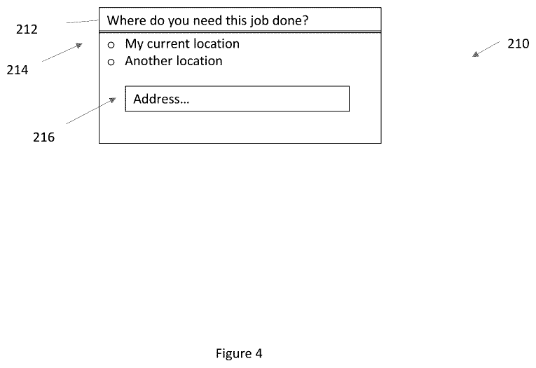

FIG. 4 is another exemplary user interface for the new job entry which may be encountered by the hiring user at step 104B of FIG. 2 following the selection of the desired service as shown and described with respect to FIG. 3, though such is not required. The user interface may request geographic job site information 210. The hiring user may encounter a prompt 212 asking the hiring user where the service needs to be performed. Prompts to determine and utilize the hiring user's current location 214 or another location 216 may be provided. If the hiring user selects their current location 214, the app may access the hiring user device's 16 location information to determine the location for the new job entry. If the hiring user selects another location 216, the hiring user may enter the address or other location information for the new job entry.

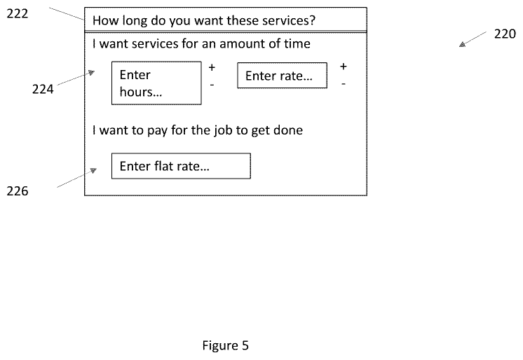

FIG. 5 is another exemplary user interface for the new job entry which may be encountered by the hiring user at step 104A of FIG. 2 following the selection of the desired service location as shown and described with respect to FIG. 3, though such is not required. The user interface may request compensation information 220. The hiring user may encounter a prompt 222 asking the hiring user how long they would like the services for and what they are willing to pay hourly. The hiring user may be permitted to choose between a set amount of time 224 or a flat rate to complete the job 226. In exemplary embodiments, the amount of time 224 may be entered in hours, though such it not required. A dollar amount would preferably be entered under the flat rate 226 prompt. The compensation options listed in FIG. 5 are merely exemplary and are not intended to be limiting.

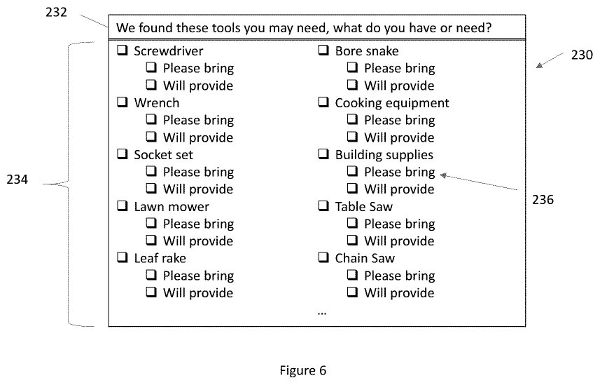

FIG. 6 is another exemplary user interface for the new job entry which may be encountered by the hiring user at step 104A of FIG. 2 following the selection of the desired service time and rate as shown and described with respect to FIG. 5, though such is not required. The user interface may request tool needed and provided information 230. The hiring user may encounter a prompt 232 asking the hiring user what tools they will need 234. In exemplary embodiments, the app may be configured to provide a predetermined list of tools 234 likely required based for the selected desired service. For each selected tool from the predefined list 234, a prompt 236 may be provided to select whether this is a tool the hiring user will provide or that needs to be brought by the worker user. The predefined tools 234 shown in FIG. 6 are merely exemplary and are not intended to be limiting.

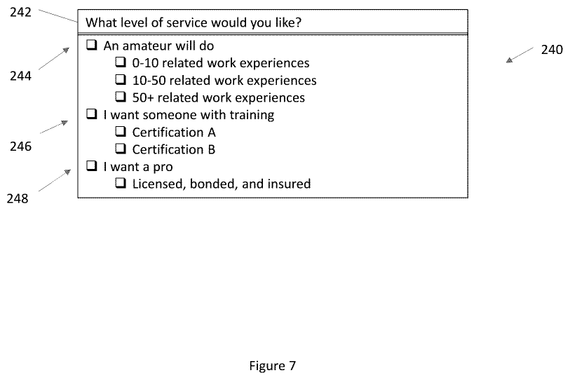

FIG. 7 is another exemplary user interface for the new job entry which may be encountered by the hiring user at step 104A of FIG. 2 following the selection of the desired tools with respect to FIG. 6, though such is not required. The user interface may comprise level of service information 240. The hiring user may encounter a prompt 242 asking the hiring user what level of service they desire. Prompts to select an amateur 244, sometime with training 246, or someone who is a professional 248 may be provided. If the amateur option 244 is selected, a sub-prompt with a range of possible experience levels may be provided. If the trained option 246 is selected, a sub-prompt with a range of possible certifications may be provided. If the professional option 248 is selected, a sub-prompt with a range of possible licensing, bonded, and insured options may be presented.

Additionally, or alternatively, the app may be configured to only permit the registration of worker users at, for example without limitation, the worker user side logic 300 if the worker user is able to show proof of various experience levels, training certifications, licenses, bonds, insurance, and the like. Such proof of experience levels, training certifications, licenses, bonds, insurance, and the like may be stored, in exemplary embodiment, at the peripheral device 22. Alternatively, or additionally, such experience levels, training certifications, licenses, bonds, insurance, and the like may be stored at the app. The experience level may be tracked by the app and automatically updated according to the number of the same or related types of jobs the worker user has completed using the app. This may advantageously permit worker user experience to be accurately tracked. This may also permit ease of updating and accurate experience information to be presented.

The training certifications may likewise be tracked by the app, through the verified completion of one or more training modules provided by or through the app. Alternatively, or in addition, such training certifications may be provided by the hiring user or a third party and verified by the hiring user for addition to the respective worker user's profile.

The order of the user interfaces presented in FIG. 3 through FIG. 7 are merely exemplary and are not intended to be limiting. It is contemplated that any number of user interfaces may be presented on any number of screens in any format and in any order.

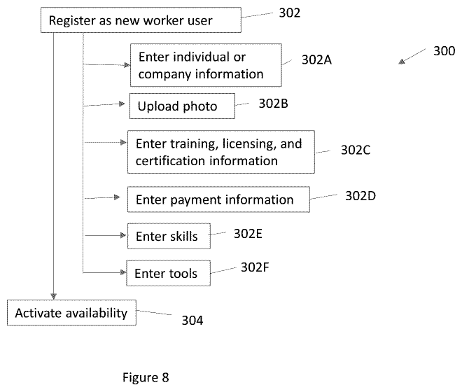

FIG. 8 is a flow chart of exemplary worker user side logic 300 for use with the system 10. In exemplary embodiments, the worker side logic 300 may be utilized with the app or website described with respect to FIG. 1. More specifically, in exemplary embodiments, the worker side logic 300 may represent steps, prompts, pages, interactions, or the like that are taken in conjunction with the operation of the app or website as utilized by a person or persons seeking to be hired. It is notable that the order of the steps provided herein is merely exemplary, any order of steps, including the repetition of one or more steps, is contemplated unless specifically stated otherwise.

In step 302, a new worker user may register with the app or website. The registration process may prompt the user to input the following information, without limitation, individual or company information (302A), a photo(s) (step 302B), training, licensing, and certification information (step 302C), payment information (step 302D), skills (step 302E), and tools (step 302F). In exemplary embodiments, the user may choose to import some or all of the information described in steps 102a-102e from another source such as, but not limited to, Facebook®, LinkedIn®, or the like.

The skills selected at step 302E may correspond with the predefined list of services 204, though such is not required. The training, licensing, and certification information at step 302C may correspond to the service levels 240. Similarly, the tools selected at step 302F may correspond with the predefined list of tools 234. Any or all of the aforementioned information, along with any other information, may be stored at the peripheral device 22, on the app, or the like.

Payment information 302D may be imported from a photo of a check, credit card, debit card, or by linking to the worker user's online banking portal. Alternatively, if the user is already registered, the user may instead log in to their existing profile. The user may be presented with an option to update their profile as desired.

At step 304, the worker user may indicate their availability status. In exemplary embodiments, without limitation, the worker user is automatically indicated as available upon connection of the peripheral device 22.

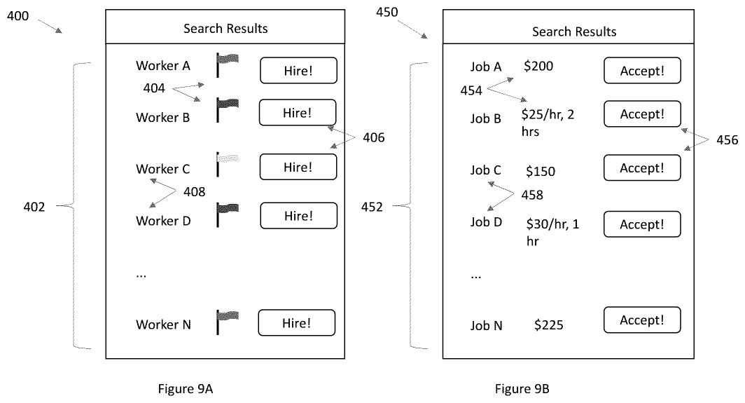

In exemplary embodiments, a number of worker users, as generally indicated at item 402, with skills, tools, and training, licensing, and certification information matching a given hiring worker's job entry may be returned to the hiring user following completion of the new job entry. Such number of worker user entries 402 may be returned in the form of a list 400 as shown in FIG. 9A. Each returned worker user entry 402 may comprise a photo, name, or brief description of the worker use 408 as well as a signal 404 located next to the returned worker user indicating the respective worker user's availability. Such a signal may include, for example without limitation, a green flag for immediate availability, a red flag for not available, and a yellow flag for availability within a certain time period (e.g., available soon). Any kind of signal is contemplated. The worker user entries 402 may be ranked by geographic proximity to the hiring user's job site, though such is not required. A selection tool 406 may be located next to each worker user entry 402 such that a given hiring user may select a given worker user.

Alternatively, or in addition, a number of jobs, as generally indicated at item 452, may be returned with service criteria, tools, and training, licensing, and certification information matching a given worker user's profile information. Such number of job entries 452 may be returned in the form of a list 450 as shown in FIG. 9B. Each returned job entry 452 may comprise a title or brief description 458 as well as a compensation rate 454 for the job. The compensation rate 454 may be shown in a time rate and the amount of time estimated for the job and/or as a flat rate for completion. An accept tool 456 may be located next to each job entry 454 such that a given worker user may accept a given job offer.

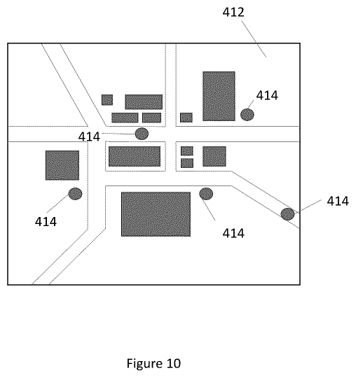

In still other exemplary embodiments, the aforementioned list of worker users 404 and/or list of job entries 454 may be presented in the form of a map 412 as shown at FIG. 10. The map 412 may be a rendering of the area in proximity to the hiring user's service site or the worker user's current location, respectively. The map 412 may comprise rendering of streets, landmarks, buildings, rivers, and the like. A number of markers 414 may be provided on the map 412. For hiring users using the app, the markers 414 may indicate nearby matching worker users. Each marker 414 may be selected by the hiring user to bring up more information about the given worker user and/or to hire the worker user to perform the job in question. For worker users using the app, the markers 414 may indicate nearby jobs. Each marker 414 may be selected by the worker user to bring up more information about the given job entry and/or to accept the job. The markers 414 may be of any size, shape, color, or the like. The markers 414, in exemplary embodiments, may flash, pop-up, or the like. For example, without limitation, when searching for certified forklift operators, each marker 414 may represent a certified forklift operator available for temporary work and in close proximity to the hiring user.

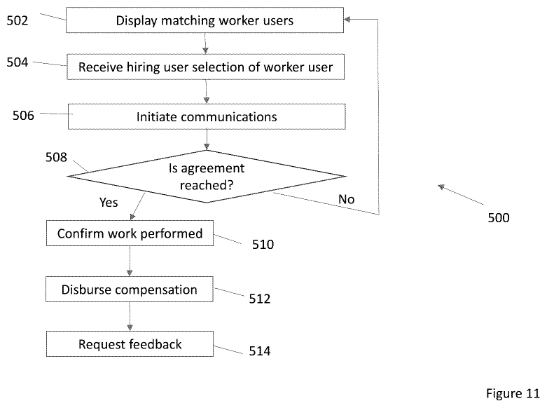

FIG. 11 is a flow chart of exemplary logic for a hiring user to hire a worker user 500. At step 502, a number of potentially matching worker users may be displayed. The matches may be displayed in a list, for example without limitation, similar to the list 400 of FIG. 9A. In other exemplary embodiments, without limitation, the matches may be displayed on a map 412 similar to FIG. 10. Regardless, at step 504 a hiring user's selection of a given worker user may be received and the worker user may be notified of his or her selection. At step 506 communications between the hiring user and the worker user may be initiated. Such communications may be accomplished by way of a chat feature. In other exemplary embodiments, the worker user's or the hiring user's contact information may be displayed. In still other exemplary embodiments, the hiring user or the worker user may be contacted through the app confidentiality such that the respective user's contact information is not revealed to the other party, but such that the respective user's phone, VOIP, text messaging, SMS messaging, chat messaging, social media, or the like messaging may be utilized to perform the communications. These communications may be used to provide further details regarding the job including for example without limitation, compensation rate, time requirements, effort requirements, skills needed, training, licensing, or certification needed, tools needed, tools provided, and the like.

At step 508, if an offer is made and accepted an agreement is reached. If no agreement is reached, the hiring user may return to the list of matching worker users. Assuming an agreement is reached, the worker user may show up and perform the work. The hiring user may, at step 510, confirm that the work was performed. Alternatively, or in addition, such confirmation may be documented by way of photo(s), video(s), or the like of the services performed. Such confirmation may, alternatively or in addition, by confirmed by tracking the worker user's duration of stay at the job site. At step 512, compensation may be calculated based upon the agreed terms and disbursed, preferably by way of the payment module 18. At step 514, the app may request that the hiring user provide feedback for the worker user. Alternatively, or in addition, the app may request that the worker user provide feedback regarding the hiring user. Such feedback may be, for example without limitation, a written review, a rating (e.g., 1-5 stars, etc.), some combination thereof, or the like. In exemplary embodiments, the worker user may provide a rating for the hiring user. The feedback may, for example, be an overall impression or may be broken down into categories, such as but not limited to, ease of working with, accuracy of work description, manner, and the like. Any criteria for feedback may be utilized. This feedback information may become part of the worker user or the hiring user's profile such that it is available to other app users to consider when selecting a job or a worker.

Alternative or in addition, once the hiring user selection of a worker user is received at step 504, the app may provide the worker user with directions to visit the job site and evaluate the service to be provided. This may advantageously permit the worker user and/or the hiring user to reevaluate and reconsider the job such as, but not limited to, the services needed, the tools needed, the level of services desired, the compensation rate, the time required, and the like. The job may be declined based upon the worker user's visit. Otherwise, the job may be re-negotiated as required and finalized in the app. The app may be configured to present the worker user with an option to indicate that a given job entry was misleading or incorrect. The app may be configured to remove a hiring user with misleading or incorrect job entries above a predetermined threshold.

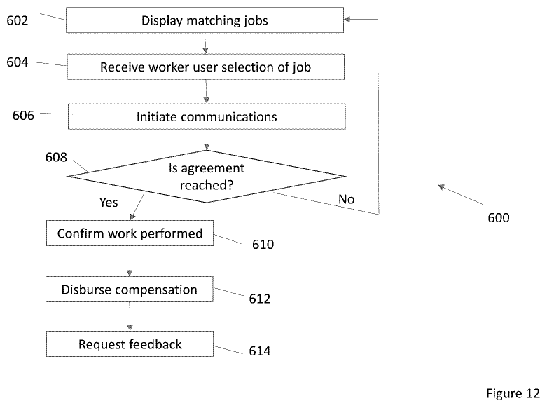

FIG. 12 is a flow chart of other exemplary logic for hiring a worker user 600. At step 602, a number of potentially matching jobs may be displayed. The matching jobs may be displayed in a list, for example without limitation, similar to the list 450 of FIG. 9B. In other exemplary embodiments, without limitation, the matches may be displayed on a map 412 similar to FIG. 10. At step 604, a user selection of a job may be received, and the hiring worker may be notified of the selection. At step 606, communications between the hiring user and the worker user may be initiated. Such communications may be accomplished by way of a chat feature. In other exemplary embodiments, the worker user's or the hiring user's contact information may be displayed. In still other exemplary embodiments, the hiring user or the worker user may be contacted through the app confidentiality such that the respective user's contact information is not revealed to the other party, but such that the respective user's phone, VOIP, text messaging, SMS messaging, chat messaging, social media, or the like messaging may be utilized to perform the communications. These communications may be used to provide further details regarding the job including for example without limitation, compensation rate, time requirements, effort requirements, skills needed, training, licensing, or certification needed, tools needed, tools provided, and the like.

At step 608, if an offer is made and accepted, an agreement is reached. If no agreement is reached, the hiring user may return to the list of matching worker users. Assuming an agreement is reached, the worker user may show up and perform the work. The hiring user may, at step 610, confirm that the work was performed. At step 612, compensation may be calculated based upon the agreed to terms and disbursed, preferably by way of the payment module 18. At step 614, the app may request that the hiring user provide feedback for the worker user. Alternatively, or in addition, the app may request that the worker user provide feedback regarding the hiring user. Such feedback may be, for example without limitation, a written review, a rating (e.g., 1-5 stars, etc.), some combination thereof, or the like. In exemplary embodiments, the worker user may provide a rating for the hiring user. The feedback may, for example, be an overall impression or may be broken down into categories, such as but not limited to, ease of working with, accuracy of work description, manner, and the like. Any criteria for feedback may be utilized. This feedback information may become part of the worker user or the hiring user's profile such that it is available to other app users to consider when selecting a job or a worker.

Alternative or in addition, once the worker selection of a job is received at step 604, the app may provide the worker user with directions to visit the job site and evaluate the service to be provided. This may advantageously permit the worker user and/or the hiring user to reevaluate and reconsider the job such as, but not limited to, the services needed, the tools needed, the level of services desired, the compensation rate, the time required, and the like. The job may be re-negotiated as required and finalized in the app. The app may be configured to present the worker user with an option to indicate that a given job entry was misleading or incorrect. The app may be configured to remove a hiring user with misleading or incorrect job entries above a predetermined threshold.

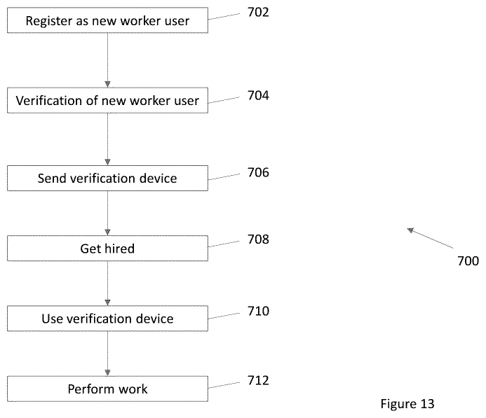

FIG. 13 is a flow chart of exemplary logic for worker verification 700. A new worker user may be registered at step 702. Such registration may be made, for example without limitation, as discussed with respect to step 102 of FIG. 2. The worker user's information may be verified at step 704. Such verification, for example without limitation, may be made to the information provided at step 102A-C of FIG. 2, and may be independently verified by a third party, by information on the peripheral device 22, and/or the new worker user may be requested to provide corroborating documentation, which may be stored on the server 12 or the peripheral device 22. Verification, including but not limited to independent verification or request for corroborating documentation, is contemplated for any information.

Regardless, once the new user worker's information is verified, the new worker user may be sent a verification device 20 at step 706. As will be explained in further detail herein, the verification device 20 may be a separate tangible item or may be an electronic item, such as but not limited to, a code or password. The verification device 20 may be stored on the peripheral device 22 and may be linked to a verification certificate, images of corroborating documentation, or the like. After the worker user receives a hire notification and an agreement may be reached at step 708. The worker user may show up and use the verification device at step 710 to verify that he or she is the hired worker. Once verified, the worker user may perform the services at step 712. Performance may, in exemplary embodiments without limitation, be subsequently confirmed, payment may be disbursed, and reviews may be requested.

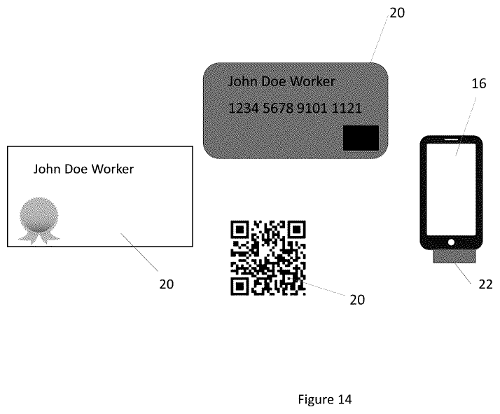

FIG. 14 is an exemplary verification system for use with the system 10 and the verification logic 700 of FIG. 13. The verification device 20 may be an ID card, a chip, RFID, QR code, bar code, other code, passphrase, or the like. The verification device 20 may be read, scanned, processed, viewed, or otherwise used by the hiring user. In exemplary embodiments, the verification device is read, scanned, processed, viewed, or otherwise used by way of the user device 16. In exemplary embodiments, without limitation, the verification device 20 is a unique code which can be read or utilized by the hiring user (for example, without limitation, by way of the user device 16) to verify that the person who appears to perform the work is the worker user the hiring user hired via the app. The verification device 20 may also serve to match the worker user and the hiring user to the job transaction stored by the app. Additionally, or alternatively, the verification device 20 gives the hiring user assurances that the worker user possesses the skills, experience, or the like described by the worker user on the app.

The verification device 20 may be a physical device sent to the worker user. For example, without limitation, the verification device 20 may be a card with a chip or a magnetic strip. In such exemplary embodiments, the chip, magnetic strip, or other portion of the card may be read by a card reader. The card reader may be the user device 16, a component attached thereto, or a separate device. As another example, again without limitation, the verification device 20 may be an electronic code, such as but not limited to a QR code. In such exemplary embodiments, the electronic code may be read by the user device 16, a component attached thereto, or a separate device. The verification device 20 may be located at the peripheral device 22, though such is not required. As a further example, again without limitation, the verification device 20 may be an ID card, certificate, or badge that is presented to the hiring user.

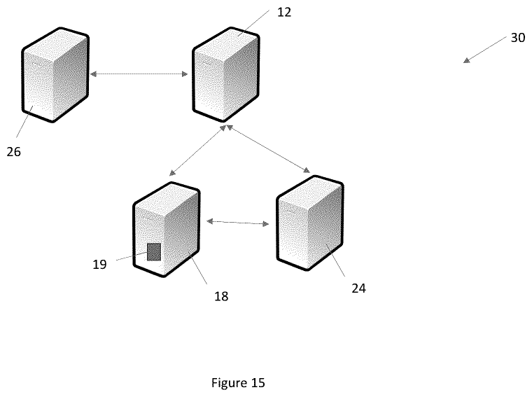

FIG. 15 is a plan view of another exemplary payment and pricing system 30. The payment system 30 may be an extension of the system 10 shown and described with respect to FIG. 1, though such is not required. The server 12 may be in electronic communication with a pricing module 26. In exemplary embodiments the server 12, by way of the pricing module 26, may be configured to determine one or more pricing options. For example, without limitation, the pricing module 26 may comprise data representing customary pricing for each of the predefined service tasks 204. This customary pricing may be geographic specific. The app may be configured to set the compensation rate for a given job by way of the customary pricing.

Alternatively, or in addition, the pricing module 26 may place the hiring user for a given job in electronic communication with multiple worker users by way of a chat or other communication tool. This may permit the hiring user to bid the job out to multiple worker users. The pricing module 26 may be configured to automatically submit a request for quote to multiple matching worker users. The worker users may be given an amount of time to respond. The pricing module 26 may be configured to automatically select the highest bid at the close of the bidding window. In other exemplary embodiments, the hiring user may be presented with all bids and permitted to pick the worker user to hire.

The server 12 may be in electronic communication with the payment submodule 18 as well as a payment database 24. The payment database 24 may comprise payment information, such as but not limited to, the payment information collected with respect to step 102B of FIGS. 2 and 302D of FIG. 8, though such is not required. Such payment information may include, but is not limited to, credit card information, debit card information, bank account information, gift card balances, account balances, tip information, some combination thereof, or the like.

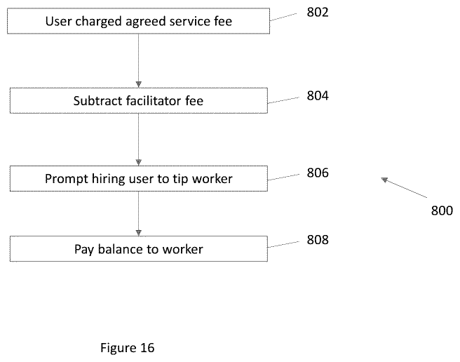

FIG. 16 is a flow chart of exemplary logic, as generally indicated at item 800, for the payment system of FIG. 15. Once the work is performed and confirmed as completed, the compensation may be calculated for disbursement as shown and described in steps 510, 512, and 514 of FIGS. 11 and 610, 612, and 614 of FIG. 12 for example without limitation. As part of the calculation the user may be charged the agreed service fee at step 802. A facilitator fee may be subtracted at step 804. The facilitator fee may be a percentage of the agreed service fee or a flat rate. At step 806, the app may be configured to prompt the hiring user to tip the worker user. In exemplary embodiments, the prompt may include one or more suggested tip amounts, such as but not limited to, no tip, 15%, 20%, 25%, a custom amount, $1, $3, $5, $10, some combination thereof, or the like. At step 808 the balance may be paid to the worker user. The balance paid may be the agreed service fee, minus the facilitator fee, plus the tip. The facilitator fee may be separately provided to the app facilitator or other third party. Such payment may occur automatically once the tip amount is indicated at step 806, though such is not required.

In exemplary embodiments, the payment database 24 may comprise the transactional information required to initiate and complete the necessary transactions. The payment database 24 may further serve a bookkeeping role and keep a record of total amounts paid to various worker users, by various hiring users, and to the app administrator in terms of facilitation fees. The payment module 18 may complete the transactions by charging or debiting the appropriate accounts and crediting or depositing the other appropriate accounts. Such transactions may be performed by a payment processor 19. The payment module 18 may also issue receipts which are stored at the payment database 24.

In exemplary embodiments, the electronic peripheral devices 22 may serve as the verification devices 20 such that a separate verification device 20 is not required and/or that the verification device 20 and the electronic peripheral device 22 are provided in a single, unitary device or object. Alternatively, or additionally, some or all of the verification devices 20 may comprise the electronic peripheral devices 22.

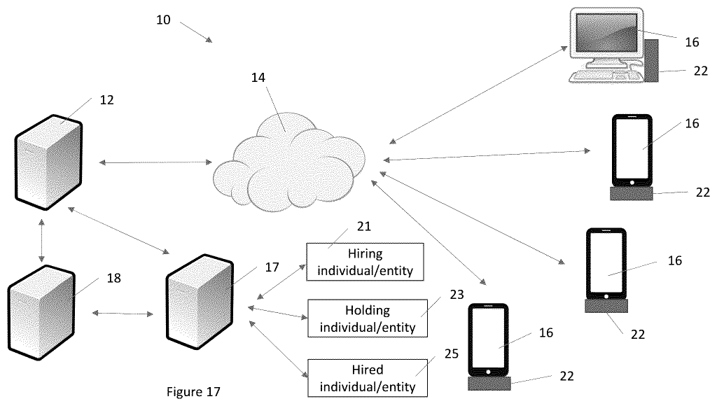

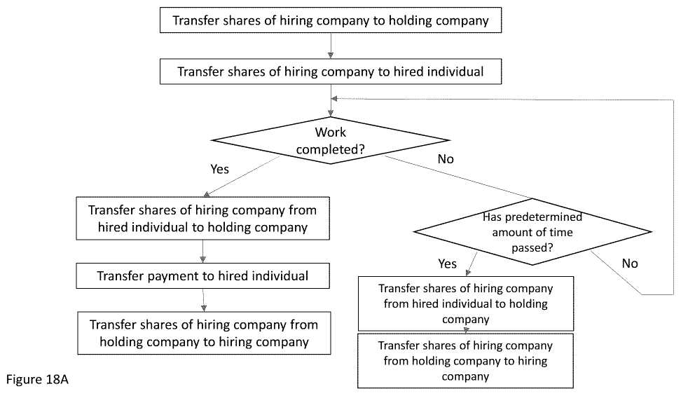

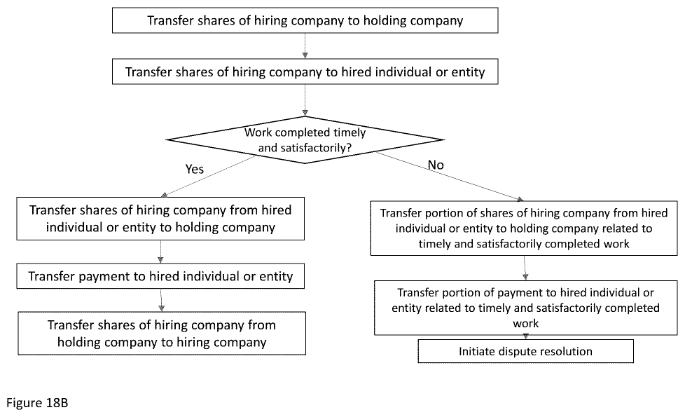

FIG. 17 illustrates another exemplary embodiment of the system 10, and FIGS. 18A-18B illustrates exemplary logic for the same. The system 10 may comprise an ownership exchange subsystem 17. The ownership exchange subsystem 17 may be configured to electronically transfer a partial ownership interest in the hiring entity 21 to a holding entity 23. The holding entity 23 may be, or may be associated with, the entity operating the system 10, though such is not required. The ownership exchange subsystem 17 may be configured to automatically and electronically produce, and at least partially fill in, form documents memorializing such transfer. Such form documents may be automatically and/or electronically executed by, or on behalf of, the hiring entity 21 such as based on prior terms of service established by the holding entity 23 and/or the operator of the system 10. Execution of such prior terms of service and/or electronic transfer may occur upon establishing the hiring entity 21 with the system 10, such as prior to issuance of the electronic peripheral device 22, though such is not required. In other exemplary embodiments, such electronic transfer may occur upon establishing a work agreement between the hiring entity 21 and a hired individual or entity 25.

The ownership exchange subsystem 17 may be configured to electronically transfer such partial ownership interests of the hiring entity 21 from the holding entity 23 to the temporarily hired individual or entity 25. The ownership exchange subsystem 17 may be configured to automatically and electronically produce, and at least partially fill in, form documents memorializing such transfer. Such form documents may be automatically and/or electronically executed by, or on behalf of, the hired individual or entity 25 such as based on prior terms of service established by the holding entity 23 and/or the operator of the system 10. Execution of such prior terms of service and/or electronic transfer may occur upon establishing the hired individual or entity 25 with the system 10, such as prior to issuance of the electronic peripheral device 22, though such is not required. In other exemplary embodiments, such electronic transfer may occur upon establishing a work agreement between the hiring entity 21 and the hired individual or entity 25.

The ownership exchange subsystem 17 may be configured to automatically revert the partial ownership interest back to the holding entity 23 and/or operator of the system 10 upon indication that the work is complete, such as transmitted for the user device 16 associated with the hiring entity 21. Such reversion may be made by way of the already executed agreements or new agreements automatically and electronically produced, and at least partially filled in, by the ownership exchange subsystem 17. Upon such reversion, the payment processing module 18 may be configured to automatically and electronically disburse compensation to the hired individual or entity 25. In exemplary embodiment, such compensation may be held, such as in escrow, by the holding entity 23 and/or operator of the system 10 while the work is underway. In other exemplary embodiments, the amount disbursed may be charged to the hiring entity 21, such as in exchange for reversion of the partial ownership interest in the hiring entity 21. Such disbursement may be in the form of one or more cryptocurrencies, electronic transfer, electronic check, combinations thereof, or the like. The ownership exchange subsystem 17 may be configured to automatically and electronically establish a temporary partial ownership interest by the hired individual or entity 25 in the hiring entity 21. While this temporary partial ownership interest may be made by way of the holding entity 23, such is not necessarily required.

In exemplary embodiments, the ownership exchange subsystem 17 may be configured to only permit transfer of the temporary partial ownership interest in the hiring entity 21 to the hired individual entity 25 while the electronic peripheral devices 22 of the hiring entity 21 and/or the hired individual or entity 25 are electronically connected to the respective user devices 16. Upon disconnection of one or both to the electronic peripheral devices 22, the ownership exchange subsystem 17 may be configured to automatically and electronically revert the transfer. This may be evidenced by the form documents, in exemplary embodiments. If the system 10 receives indication that the work is completed upon, prior to, or after such disconnection, then the ownership exchange subsystem 17 may be configured to automatically and electronically disburse payment.

As illustrated with particular regard to FIGS. 18A-18B, the ownership exchange subsystem 17 may be configured to automatically and electronically revert transfer of shares if the work is not completed in a predetermined amount of time. The predetermined amount of time may be a number of hours, days, weeks, or the like and may run from indication of acceptance in exemplary embodiments. Such share reversion may be performed without payment to the hired individual or entity 25. In this manner, the hiring entity 21 and/or the holding entity 23 and/or operator of the system 10 may not be required to pay for work that is not performed. Alternatively, or additionally, this procedure may be followed with no or partial payment for partially completed or unsatisfactory completed work, such as reported by the hiring entity 21. Alternatively, or additionally, a balance of payment due and/or an equivalent portion of shares may be held, such as in escrow, by the holding entity 23 and/or operator of the system 10 in the case of reported partially completed or unsatisfactory completed work. Such funds and/or shares may be held for a period of time while a dispute resolution is undertaken, such as but not limited to a mediation, arbitration, and/or judicial proceeding. The predetermined amount of time for work to be completed, the withholding of funds and/or shares, the dispute resolution procedure, combinations thereof, or the like may be included in the already executed agreements or new agreements automatically and electronically produced, and at least partially filled in, by the ownership exchange subsystem 17.

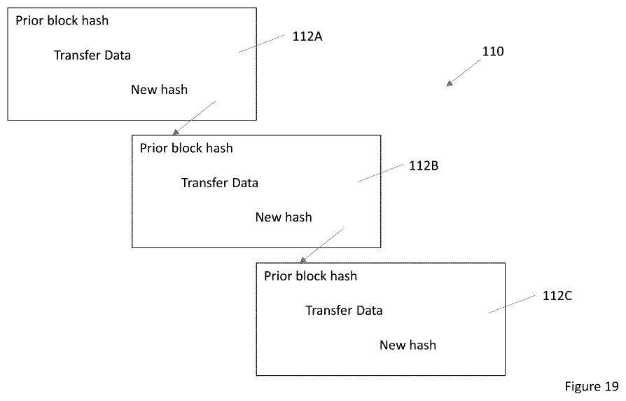

FIG. 19 illustrates an exemplary blockchain 110 for use with the system 10. The system 10 may be configured to store and/or maintain one or more blockchains 110. The blockchain(s) 110 may, for example without limitation, store information regarding the partial ownership interest, electronic transfers of the partial ownership interest, jobs posted, jobs accepted, term of acceptance, the hiring individual or entity 21, the hired individual or entity 25, the holding entity 23, combinations thereof, or the like. In exemplary embodiments, the ownership exchange subsystem 17 may be configured to automatically and electronically generate blocks 112A, 112B, 112C with each electronic transfer of any partial ownership interest in any hiring entity 21 to the holding entity 23, system 10 operator, hired individual or entity 25 combinations thereof, or the like. The ownership exchange subsystem 17 may be configured to, alternatively or additionally, automatically and electronically generate blocks 112A, 112B, 112C regarding posted jobs, accepted jobs, terms of acceptance, information regarding hiring individual or entity 21, the hired individual or entity 25, the holding entity 23, combinations thereof, or the like. Each of the blocks 112A, 112B, 112C may comprise a hash of a prior one of the blocks 112A, 112B, 112C and a new hash.

Each of the electronic peripheral devices 22 may comprise computing resources for verifying the authenticity of each newly issued block 112A, 112B, 112C. In an exemplary embodiment, once at least majority of the electronic peripheral devices 22 accept the authenticity of new blocks 112A, 112B, 112C, the blockchain(s) 110 may be updated. In other exemplary embodiments, the ownership exchange subsystem 17 may have exclusive or final control over accepting new blocks 112A, 112B, 112C. In other exemplary embodiments, such resources may instead reside on the user device 16, such as but not limited to, within applications or other software installed thereon.

A separate blockchain 110 may be generated for each hiring entity 21, each job posting, each hired individual or entity 25, combinations thereof, or the like. In such embodiments, new blocks 112A, 112B, 112C may be added to the related ones of the blockchain(s) 110 upon agreement as to authenticity by some or all of the ownership exchange subsystem 17 and/or electronic peripheral devices 22 associated with the parties related to a particular job. For example, without limitation, a new blockchain 110 may be generated by the ownership exchange subsystem 17 when a job posted by a hiring entity 21 is accepted by a hired individual or entity 25 to record electronic transfer of the partial ownership interest to/from the hiring entity 21, the holding entity 23, and/or the hired individual or entity 25. The authenticity of these blocks 112A, 112B, 112C may be authenticated by the electronic peripheral devices 22 of the hiring entity 21 and/or the hired individual or entity 25, but not necessarily of other users 16 which are not parties to the transaction to improve speed of authentication. However, such additional verification may be utilized for added assurance of authenticity. The ownership exchange subsystem 17 may also generate one or more new blocks 112A, 112B, 112C regarding disbursement of electronic payment, such as to/from the hiring entity 21, the holding entity 23, and/or the hired individual or entity 25.

Alternatively, or additionally, the ownership exchange subsystem 17 may be used to provide a form of ownership, membership, and/or some other interest by worker users with a larger entity. This may be used to provide buying power for items like insurance, benefits, combinations thereof, or the like. Fees and expenses for such items may be deducted from disbursed payments. The ownership exchange subsystem 17 may, alternatively or additionally, provide a form of ownership, membership, and/or some other interest by hiring users with the larger entity. This may allow hiring users to sponsor certain items like insurance, benefits, combinations thereof, or the like. Fees and expenses for which may be included with those invoiced, charged, dedicated, or the like for the hiring user. The fees and expenses by the hiring and/or worker users may be generated on a task basis, periodically (e.g., monthly dues or subscription), combinations thereof, or the like.

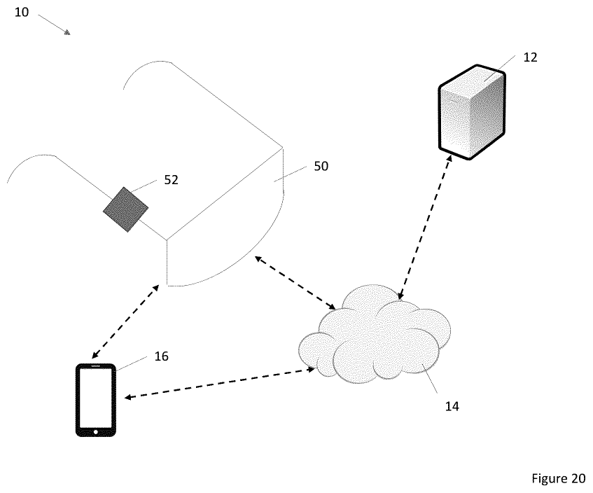

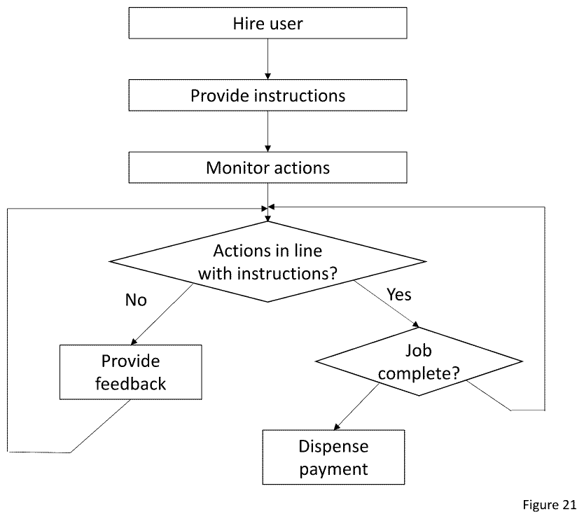

FIG. 20 and FIG. 21 illustrate another exemplary embodiment of the system 10. The system 10 may include one or more augmented reality (“AR”) devices 50. The AR devices 50 may be issued to hired persons or may be provided by such hired persons. The AR devices 50 may optionally serve as, or be provided in addition to, the electronic peripheral devices 22. The AR devices 50 may optionally provide some or all of the functions of the electronic peripheral devices 22. For example, without limitation, pairing, connection, and/or presence of the AR devices 50 may be used to signal worker user availability and/or to authenticate the worker user. The AR devices 50 may optionally serve as, or be provided in addition to, the user devices 16. The AR devices 50 may optionally provide some or all of the functions of the user devices 16.

The AR devices 50 may include, for example without limitation, various mixed reality type devices such as smart glasses and/or headsets, the HOLOLENS available from Microsoft (https://www.microsoft.com/en-us/hololens), the VISION PRO device available from Apple (https://www.apple.com/apple-vision-pro/), combinations thereof, or the like.

Information, such as but not limited to, movies, images, written instructions, combinations thereof, or the like, may be presented at the AR devices 50. Such information may be provided by way of the server(s) 12 and/or network(s) 14 to the user device 16 and/or AR devices 50. Such information may include, for example without limitation, instructions on how to perform the job, such as, but not necessarily limited to, demonstrative, guided images or movies. Such instructions may be presented to guide the worker user in performing their job. For example, without limitation, a preferred pattern for folding towels for a hired housekeeper may be presented. As another example, a particularly efficient or aesthetically pleasing patterns for lawn care may be presented. These examples are provided without limitation, a person of skill in the art will appreciate that a wide variety of applications exist, and these disclosures are not intended to be bound to any particular examples.

Alternatively, or additionally, tracking devices 52 may be provided. The tracking devices 52 may be integrated or provided separately. The tracking devices 52 may track at least certain movements or other actions by the hired person (e.g., location, orientation in space, items generated combinations thereof, or the like). The tracking devices 52 may comprise GPS devices, accelerometers, gyroscopes, cameras, machine vision software, other optical sensors, microphones, combinations thereof, or the like.

The tracking devices 52 may be used for operation of the AR device 52 (e.g., to accurately present the information spatially relative to the worker user's position and/or movements), to provide feedback (e.g., if worker doing job in accordance with instructions or not), and/or to provide the hiring user with at least a reasonable level of confidence that the worker user is performing the job in question and/or performing in the manner desired (e.g., in line with instructions, in an efficient manner, etc.). For example, without limitation, where movements are sensed that are not in line with instructions (e.g., location differing from desired patterns of lawn mowing), then notifications or other feedback (e.g., remedial instructions) may be presented automatically at the AR device 50. As another example, without limitation, images (e.g., captured by camera or other optical sensors) of a completed item of manufacture may not align with a desired or instructed output (e.g., parts placed incorrectly, welded at wrong location, wired incorrectly, etc.). As those of skill in the art will appreciate, such tracking and feedback may be used for a wide variety of tasks. Such progress and/or performance may be tracked through worker user movements and/or machine vision analysis of worker surroundings (e.g., environmental or work output). For example, a worker's movements may be determined, at least in part, by machine vision of surroundings. Alternatively, or additionally, a worker's work output may be determined, at least in part, by machine vision of work output (e.g., item the worker user is working on).

Alternatively, or additionally, the information from the tracking devices 52 may confirm when a job is completed such as to prompt payment or other items (e.g., reviews, etc.).

Payment may include deductions, such as for elected worker user benefits, larger entity fees, membership fees, ownership fees, taxes, and/or may include items such as tips, bonuses, combinations thereof, or the like. Alternatively, or additionally, fees may be automatically added to invoices and/or charges presented to the hiring user.

Fees may be deduced from otherwise determined pay for a worker user for various performance reasons, such as but not limited to, where a task is not performed in accordance with instructions and/or takes longer than expected, such as determined by the data form the tracking devices 52 compared to agreed terms and/or instructions by way of non-limiting example. Alternatively, or additionally, bonuses may be added to otherwise determined pay for a worker user for various performance reasons, such as but not limited to, where a task is performed in accordance with instructions and/or takes less time than expected, such as determined by the data form the tracking devices 52 compared to agreed terms and/or instructions.

Payments may be automatically determined by the application and charged to the hiring user and/or disbursed to the worker user accordingly.

While AR devices 50 are shown and/or described, such information may, alternatively or additionally, be presented at other types or kinds of devices (e.g., smartphones, tablets, personal computers, etc.), such as when serving as the user devices 16.

The peripheral devices 22 may comprise one or more biometric authentication tools, such as but not limited to, fingerprint scanning, facial recognition, voice recognition, pupil recognition, DNA sampling, combinations thereof, or the like.

Tracking devices 52 and/or at least some of the functionality related to the same may be provided with or without the AR devices 50. For example, the tracking devices 52 may be devices worn and/or configured to be attached to a body part of the worker user. The tracking devices 52 may be dedicated devices or part the user devices 16 (e.g., smart watches). Alternatively, or additionally, the tracking devices 52 may form part of multiple user devices 16, such as but not limited to one or more of: AR devices 50, smartphones, smartwatches, dedicated tracking devices 52, and the like. In this fashion, the location data may be derived from multiple sources, such as to provide more comprehensive and/or accurate tracking.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

Certain operations described herein may be performed by one or more electronic devices. Each electronic device may comprise one or more processors, electronic storage devices, executable software instructions, and the like configured to perform the operations described herein. The electronic devices described herein may be general purpose or specialized devices. The electronic devices may be personal computers, smartphone, tablets, databases, servers, or the like. The electronic connections described herein may be accomplished by wired or wireless means.

What is claimed is:

1. A system for instructing persons hired to perform services on a temporary basis, said system comprising:
electronic devices associated with hiring users (“hiring user devices”);
electronic devices associated worker users (“worker user devices”), wherein at least some of the worker user devices comprise augmented reality (“AR”) devices; and
one or more servers hosting an application operable with the hiring user devices and the worker user devices by way of one or more networks, wherein the one or more servers comprise executable software instructions associated with the application, which when executed, configure one or more processors to:
receive indication of agreement between a respective one of the worker users and a respective one of the hiring users to hire the respective worker user on a temporary basis to perform a task; and
cause information related to the task to be displayed at a respective one of the AR devices associated with the respective worker user.

2. The system of claim 1 wherein:
said information comprises instructions for performing the task.

3. The system of claim 2 wherein:
said instructions comprise at least one movie.

4. The system of claim 2 wherein:
the AR devices comprise tracking devices; and
said one or more servers comprise executable software instructions associated with the application, which when executed, configure the one or more processors to:
record information from the tracking device of the respective AR device; and
provide feedback at the respective AR device where the recorded information indicates that the task is not being performed in accordance with the instructions.

5. The system of claim 2 wherein:
the AR devices comprise tracking devices; and
said one or more servers comprise executable software instructions associated with the application, which when executed, configure the one or more processors to:
record information from the tracking device of the respective AR device; and
determine completion of the task based on the recorded information.

6. The system of claim 5 wherein:
said one or more servers comprise executable software instructions associated with the application, which when executed, configure the one or more processors to in response to determining completion of the task, disburse payment to the respective worker user.

7. The system of claim 6 wherein:
the disbursed payment includes elected deductions.

8. The system of claim 6 wherein:
said one or more servers comprise executable software instructions associated with the application, which when executed, configure the one or more processors to deduct a fee from disbursed payment where completion of the task takes longer than expected and add a bonus to the disbursed payment where completion of the task takes less time than expected.

9. The system of claim 1 wherein:
said one or more servers comprise executable software instructions associated with the application, which when executed, configure the one or more processors to determine that the AR device of the respective worker user is connected, and in response, signal availability of the respective worker user.

10. The system of claim 1 wherein:
said one or more servers comprise executable software instructions associated with the application, which when executed, configure the one or more processors to determine that the AR device of the respective worker user is connected, and in response, indicate successful authentication of the respective worker user.

11. The system of claim 1 wherein:
said one or more servers comprise executable software instructions associated with the application, which when executed, configure the one or more processors to facilitate transfer of an ownership or membership interest to a larger entity by each of the worker users.

12. The system of claim 11 wherein:
said one or more servers comprise executable software instructions associated with the application, which when executed, configure the one or more processors to facilitate transfer of an ownership or membership interest to the larger entity by each of the hiring users.

13. A system for instructing persons hired to perform services on a temporary basis, said system comprising:
electronic devices associated with hiring users (“hiring user devices”);
electronic devices associated worker users (“worker user devices”), each comprising augmented reality (“AR”) devices, wherein each of the AR devices comprise at least one tracking device; and
one or more servers hosting an application operable with the hiring user devices and the worker user devices by way of one or more networks, wherein the one or more servers comprise executable software instructions associated with the application, which when executed, configure one or more processors to:
determine that the AR device of the respective worker user is connected, and in response, signal availability of the respective worker user and indicate successful authentication of the respective worker user;
receive indication of agreement between a respective one of the worker users and a respective one of the hiring users to hire the respective worker user on a temporary basis to perform a task;
cause instructions, comprising at least one movie, for performing the task to be displayed at a respective one of the AR devices associated with the respective worker user;
record location information from the tracking device of the respective AR device; and
provide feedback at the respective AR device where the recorded location information indicates that the task is not being performed in accordance with the instructions;
determine completion of the task based on the recorded location information, and in response, disburse payment to the respective worker user.

14. The system of claim 13 wherein:
the disbursed payment includes deductions.

15. The system of claim 14 wherein:
said one or more servers comprise executable software instructions associated with the application, which when executed, configure the one or more processors to facilitate transfer of an ownership or membership interest to a larger entity by each of the worker users and each of the hiring users.

16. The system of claim 15 wherein:
the deductions are specific to the respective worker user.

17. A method for instructing persons hired to perform services on a temporary basis, said method comprising:
associating electronic devices associated with hiring users (“hiring user devices”);
associating electronic devices associated worker users (“worker user devices”), wherein at least some of the worker user devices comprise augmented reality (“AR”) devices; and
receiving, by way of an application operable with the hiring user devices and the worker user devices indication of agreement between a respective one of the worker users and a respective one of the hiring users to hire the respective worker user on a temporary basis to perform a task; and
displaying, at the AR device of the respective one of the worker users, information related to the task, said information comprising instructions for performing the task comprising at least one movie.

18. The method of claim 17 further comprising:
recording, by way of data received from tracking devices of the AR devices, information from the tracking device of the respective AR device;
providing feedback at the respective AR device where the recorded information indicates that the task is not being performed in accordance with the instructions.

19. The method of claim 17 further comprising:
recording, by way of data received from tracking devices of the AR devices, information from the tracking device of the respective AR device; and
determining completion of the task based on the recorded information, and in response, disbursing payment to the respective worker user, wherein the disbursed payment includes elected deductions by the respective hiring user.

20. The method of claim 17 further comprising:
determining that the AR device of the respective worker user is connected, and in response, at least one of:
signaling, by way of the application, availability of the respective worker user; and
indicating successful authentication of the respective worker user.
